(19) United States
(12) Patent Application Publication
(10) Pub. No.: US 2011/0302090 A1
(43) Pub. Date: Dec. 8, 2011

(54) Determining a Critical Path in Statistical Project Management

(76) Inventors: Richard Newpol, Mars, PA (US); Robert Ditmore, Cranberry Twp, PA (US)

(21) Appl. No.: 12/793,473

(22) Filed: Jun. 3, 2010

(51) Int. Cl. G06Q 10/00

(52) U.S. Cl. 705/301; 705/348

(57) ABSTRACT

An apparatus for a Gantt chart includes a processing unit which determines a range of dates for an end date for completing a task. The range comprises a first date and a final date. The apparatus includes a display which shows the range of dates for the task completion. A method for a Gantt chart includes the steps of determining a range of dates for an end date for completing a task with a processing unit. The range comprises a first date and a final date. There is the step of showing on a display the range of dates for the task completion. There is the step of showing on a display the range of the end date. An apparatus for establishing a project's performance. A method for establishing a project's performance.

### TECHNICAL FIELD

The present invention is related to determining a range for an end date of a task. (As used herein, references to the “present invention” or “invention” relate to exemplary embodiments and not necessarily to every embodiment encompassed by the appended claims.) More specifically, the present invention is related to determining a range for an end date of a task and a range of a project end date from a range of end dates for all tasks of the project, including establishing dates for each task end date based on a completion date for the project.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

When planning or managing Engineering development projects, many times traditional project planning tools are used. These tools generally assume that a project can be broken up into tasks, and each task has a definite amount of work associated with it. The main focus of such tools is to manage collections of tasks and resources. Then provide a mapping of resources to tasks and defining pre-requisites and other sequential conditions. One main output of these tools is the set of projected resource utilizations and completion dates for various phases or the entire project.

The main problem with using traditional project planning tools is that Engineering Development projects typically encompass a great deal of unknowns. Typically, it is not known with complete certainty how long a task may take, so Engineers may give a range for the amount of time to complete a task.

Unfortunately, since traditional project management tools use only fixed durations for tasks, these estimated ranges are discarded, and some fixed value within the range is used instead. There are many techniques available to project managers for getting estimates for task duration, including Delphi technique, three-point technique and wide-band delphi technique [3]. However, these techniques require either expert advice or historical data. The techniques however take time and some expertise to apply, while still avoiding the inherent uncertainty in developing projects that are unique or have some unique aspect requiring engineering to investigate unknown areas. Therefore, the uncertainty in the task, which is represented by the range estimate, is lost.

As a consequence, the overall project plan created with this approach does not contain any measure or indication of these uncertainties. It is not known to what degree of confidence the project schedule adheres. Since task dependencies do not carry the uncertainty, the potential error in completion projections multiplies for a series of dependent tasks.

When planning or managing engineering development projects, many times it is not exactly known how much time a project subtask will take. Therefore, it is common practice to estimate the amount of time for a development task with a minimum and maximum amount of time. Since traditional project planning techniques expect a single fixed amount of time to plan for each subtask, the typical method is to pick fixed durations somewhere between the estimated minimums and maximums for the subtasks, and produce a project schedule from those estimates.

The main problem in selecting arbitrary durations from initial range estimates is that this causes both a loss of information (the original estimates) as well as a project schedule with no corresponding confidence factor. Therefore, it is not known by project planners or managers what degree of risk should be attributed to the resulting plan.

In addition, since project planners will often use a ‘rule of thumb’ to pick a value (such as taking the mid-point between minimum and maximum estimates), and the compound risk associated with inter-task dependencies is never accounted for, the resulting schedule usually has a much lower (yet unknown) risk associated with it, than would generally be considered acceptable. In fact, studies have shown that traditional project plans created using this technique typically carry a confidence level as low 20% [4].

When managing engineering development projects, it is common for project managers to use a Gantt Chart to show the expected durations of subtasks, as well as the time order and relationships between them [5]. Such a chart is designed to show the expected progress of a project over time, by aligning the start and end dates of the various subtasks (see FIG. 3).

Since the Gantt Chart displays subtasks as rectangle diagrams with fixed start and end dates, it cannot represent the statistical nature of the task completion functions defined by Statistical Project Management. As a consequence, a fixed confidence level must be chosen in order to derive a Gantt Chart or similar representation from statistical project estimates.

What is needed is a way to visually represent a task without losing the significant statistical attributes related to the uncertainty of task start and end dates, yet still retain the ease, familiarity, and timeline context of a Gantt-style representation.

When managing Engineering development projects, it is common for project managers to want to identify the subtask or chain of subtasks which are the ‘last’ tasks to be complete; the ones essentially gating the project completion. This chain is called the “critical path’ and because of the direct (day-for-day) effect on the project completion, usually represents the tasks of most interest to project managers [6]. As projects progress and unexpected events occur, the critical path may change as some tasks slip out and become part of a new critical path driving overall project completion.

One well-known problem with managing to a critical path is that since the critical path defines a single chain of subtasks, it can often cause other tasks of similar importance to be overlooked. If two tasks end at nearly the same time, the later one may be identified as critical, while the (slightly) earlier one gets ignored. Subsequent changes as a project progresses, can cause a completely different set of subtasks to suddenly become the critical path with little warning to project managers, unless extensive analysis of schedules beyond the critical path is constantly performed.

Another problem with traditional Critical Path management is that it is not directly applicable for use with Statistical Project Management. This is because all tasks contribute in some proportion to the overall project completion estimation function. If techniques are used to derive a fixed duration project plan, a traditional critical path can be identified, however, identification of this critical path ignores the contribution to the overall project duration function that non-critical path tasks do have. There is a need for some measure of importance for each subtask, analogous to the traditional critical path.

In statistical Project Management, the project completion estimation is a function of contributions from all subtasks. Therefore, an analogous concept to the traditional critical path can be a measurement of this contribution. Subtasks which contribute highly are ‘more critical’ and ones that contribute slightly are ‘less critical.’

If all subtasks are ranked by such a sensitivity measurement, project managers could quickly identify the most important tasks driving the overall project completion. Unlike a simple critical path method, this technique can simultaneously identify even otherwise unrelated tasks that have high significance toward driving the project completion. Since the list is a function of all subtasks' relationships to the overall project completion, Project managers can focus attention on the tasks most likely to affect the project outcome, without worrying about “hidden’ critical tasks.

When managing Engineering development projects, it is common for project managers to want to identify a sequence of tasks in which the last task in the sequence is also the last task to be completed in the project. This sequence of tasks is called the “critical path’ and because of the direct (day-for-day) effect on the project completion, usually represents the tasks of most interest to project managers. Other paths are said to have a “lag” of some amount, which represents amount of time a path completes ahead of the critical path. As projects progress and unexpected events occur, the critical path may change as some tasks slip out and become part of a new critical path driving overall project completion.

One well-known problem with managing to a critical path is that since the critical path defines a single chain of subtasks, it can often cause other tasks of similar importance to be overlooked. If two tasks end at nearly the same time, the later one may be identified as critical, while the (slightly) earlier one gets ignored. Subsequent changes as a project progresses, can cause a completely different set of subtasks to suddenly become the critical path with little warning to project managers, unless extensive analysis of schedules beyond the critical path is constantly performed.

Another problem with traditional Critical Path management is that it is not directly applicable for use with Statistical Project Management. This is because all tasks contribute in some proportion to the overall project completion estimation function. If techniques are used to derive a fixed duration project plan, a traditional critical path can be identified, however, identification of this critical path ignores the contribution to the overall project duration function that non-critical path tasks do have. There is a need for some measure of importance for each subtask, analogous to the traditional critical path. Although tasks can be ranked in order according to contribution to the overall project completion curve, a method which assesses the risk that a task will extend the project, would provide a more analogous metric to the non-statistical critical path.

When managing ongoing Engineering development projects, it is common for uncertainties to cause deviation from plan for various parts of the project. At the start of most Engineering development projects, there is a non-trivial amount of unknown information that can affect the progress of the project. It has been observed and postulated elsewhere that as a project progresses, the unknown information decreases, resulting in a decreasing amount of uncertainty. Put another way, the closer a project is to completion, the more confident one can be about the predicted completion date.

Knowing that the uncertainty of a project is decreasing as the project nears completion doesn't provide much usable information with respect to managing the project. This ‘gut feel’ can be difficult to quantify in real terms of uncertainty or confidence, and with traditional project management, even more difficult to continually assess the impact of ongoing deviations in individual subtasks. What is needed is a way to quantify the ‘remaining’ uncertainty as a project progresses toward completion, to give planners the ability to adjust expectations or take action to compensate for unexpected changes in project confidence.

When managing Engineering development projects with Statistical Project Management, a common datum of interest is the probability of completion by a desired date. With Statistical Project Management, a Completion Curve (CC curve) can be computed which provides the probability of completion as a function of time. A point on this curve represents the chance of completion by that date. Therefore, in order to assess completion probabilities of any task or tasks (or the entire project), a Project Manager must obtain the values from CC curves by examination. (See FIG. 1).

Analyzing CC curves can be a bit time-consuming, especially if there are many intermediate ‘checkpoints’ in a project that a manager wants to monitor. This is especially true as a project progresses, and the amount of work remaining on various tasks decreases. Quick and easy monitoring of project completion probabilities against fixed dates can give ‘at-a-glance’ status for the overall project, or any sub-projects or set of tasks within. What is needed is a way to visually represent the probability of completion for an arbitrary set of tasks against a fixed date. It should be possible to visualize the status of many such collections ‘at-a-glance’ without CC curve measurements.

When managing task-based projects, it is common for project managers to assign resources to tasks, and have estimates for the resulting cost (length of time or materials cost) associated with the specific task/resource combination. At times, there is a choice of resources (be it people or materials) that can be applied to a specific task, with a resulting tradeoff based on the selection. For example, choosing one kind of material to use might be cheaper, or person A might be able to complete a task quicker than person B.

Typically, there is no systematic way to measure or observe the projected project cost as a function of task/resource assignments, meaning that the selection of resources is done either arbitrarily, or by ‘gut feel’ based on experience with the resources and/or the tasks in the project. However, in order to better optimize the project, what is needed is a quantitative measurement of the suitability of resource application, applied as a cost factor for computing the project cost.

### BRIEF SUMMARY OF THE INVENTION

The present invention pertains to an apparatus for a Gantt chart. The apparatus comprises a processing unit which determines a range of dates for an end date for completing a task. The range comprises a first date and a final date. The apparatus comprises a display which shows the range of dates for the task completion.

The present invention pertains to a method for a Gantt chart. The method comprises the steps of determining a range of dates for an end date for completing a task with a processing unit 12. The range comprises a first date and a final date. There is the step of showing on a display 14 the range of dates for the task completion.

The present invention pertains to an apparatus for establishing a project's performance. The apparatus comprises a database having data about each task of the project, resources available to perform each task, tags which have at least one attribute about task or resource, and having a suitability module. The apparatus comprises a processing unit which executes the suitability module that compares tags of the resources and the tasks and determines which tasks are to be performed by which resources to optimize the project's performance.

The present invention pertains to a method for establishing a project's performance. The method comprises the steps of obtaining from a database data about each task of the project, resources available to perform each task, and tags which have at least one attribute about task or resource. There is the step of executing a suitability module with a processing unit that compares tags of the resources and the tasks and determines which tasks are to be performed by which resources to optimize the project's performance.

### BRIEF DESCRIPTION OF THE DRAWINGS

In the accompanying drawings, the preferred embodiment of the invention and preferred methods of practicing the invention are illustrated in which:

FIG. 1 shows a sample completion curve.

FIG. 2 is a Gantt-type project chart derived using 50% confidence.

FIG. 3 shows a typical Gantt chart.

FIG. 4 shows a Tiger Chart: Project chart comprised of task stripes.

FIG. 5 shows task stripe detail.

FIG. 6 shows an example set of tracepoints.

FIG. 7 is a block diagram of an apparatus for a Gantt chart.

FIG. 8 is a block diagram of an apparatus for establishing a project's performance.

### DETAILED DESCRIPTION OF THE INVENTION

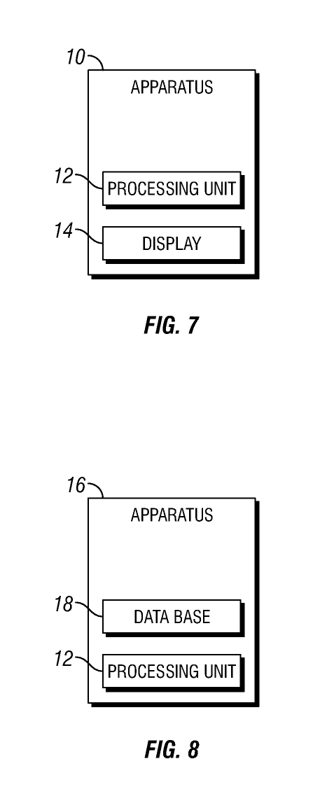

Referring now to the drawings wherein like reference numerals refer to similar or identical parts throughout the several views, and more specifically to FIG. 7 thereof, there is shown an apparatus 10 for a Gantt chart. The apparatus 10 comprises a processing unit 12 which determines a range of dates for an end date for completing a task. The range comprises a first date and a final date. The apparatus 10 comprises a display 14 which shows the range of dates for the task completion. The display 14 may be an electronic display, such as a terminal screen, or piece of paper which has the range of dates on it.

The processing unit 12 may determine a range of a project end date from a range of end dates for all tasks of the project. The processing unit 12 may establish dates for each task end date based on a completion date for the project. The processing unit 12 may produce a strip for the display 14 that shows the range in which the task can occur, the strip having a head and a tail associated with each task end date range, where the length of the head and tail corresponds to a ramp-up and a ramp down period of the associated task. The processing unit 12 may determine each task's criticality in affecting the project's completion date being met. The processing unit 12 may assess each task's risk as a function of the task's criticality, maximum duration and lag, where lag is defined as an amount of time between completion of a last task in a sequence of tasks, and the completion date of the project.

The processing unit 12 may reset the range of the end date for the task when at least a portion of the task is completed. The processing unit 12 may reset the range of the project end date after resetting the range of the end date for the task. The processing unit 12 may report a likelihood of achieving a completion date in the range of the end date.

The present invention pertains to a method for a Gantt chart. The method comprises the steps of determining a range of dates for an end date for completing a task with a processing unit 12. The range comprises a first date and a final date. There is the step of showing on a display 14 the range of dates for the task completion.

There may be the step of determining a range of a project end date from a range of end dates for all tasks of the project. There may be the step of establishing with the processing unit 12 dates for each task and date based on a completion date for the project. There may be the step of producing with the processing unit 12 a strip for the display 14 that shows the range in which the task can occur, the strip having a head and a tail associated with each task end date range, where the length of the head and tail corresponds to a ramp-up and a ramp down period of the associated task. There may be the step of determining with the processing unit 12 each task's criticality in affecting the project's completion date being met. There may be the step of the processing unit 12 assessing each task's risk as a function of the task's criticality, maximum duration and lag, where lag is defined as an amount of time between completion of a last task in a sequence of tasks, and the completion date of the project.

There may be the step of the processing unit 12 resetting the range of the end date for the task when at least a portion of the task is completed. There may be the step of the processing unit 12 resetting the range of the project end date after resetting the range of the end date for the task. There may be the step of the processing unit 12 reporting a likelihood of achieving a completion date in the range of the end date.

The present invention pertains to an apparatus 16 for establishing a project's performance, as shown in FIG. 8. The apparatus 16 comprises a database 18 having data about each task of the project, resources available to perform each task, tags which have at least one attribute about task or resource, and having a suitability module. The apparatus 16 comprises a processing unit 12 which executes the suitability module that compares tags of the resources and the tasks and determines which tasks are to be performed by which resources to optimize the project's performance.

The data in the database 18 about the tags may include a weighting associated with each tag and the suitability module, when executed by the processing unit 12, selects resources to perform tasks based on a highest number of tags which match between the resources and the tasks and also in order of the task's weighting.

The present invention pertains to a method for establishing a project's performance. The method comprises the steps of obtaining from a database 18 data about each task of the project, resources available to perform each task, and tags which have at least one attribute about task or resource. There is the step of executing a suitability module with a processing unit 12 that compares tags of the resources and the tasks and determines which tasks are to be performed by which resources to optimize the project's performance.

The data in the database 18 about the tags may include a weighting associated with each tag and the executing step includes the step of executing the suitability module by the processing unit 12 to select resources to perform tasks based on a highest number of tags which match between the resources and the tasks and also in order of the task's weighting.

In regard to the operation of the invention, the task duration uncertainties which are provided in engineering estimates are retained, and used to derive downstream task and project duration estimates. In this technique, the completion of any task (or the entire project) is itself an estimation function, giving the probability of completion by a certain date, rather than a simple fixed completion date:

In this approach, a project is considered a set of tasks to be completed, where each task has an associated resource (i.e. a person) performing the task, and an estimated range for how the long the task will take to complete. Modeling the completion of any task as a random event, and given this range for the likely time to complete a task, a probability density function [1] can be assigned to each task, which expresses the probability that the task will be completed on any given day.

This density function is based on the estimate for completing the task, and may be any appropriate density function. For example, if a task is estimated to take three to four weeks to complete, the well-known and simple Uniform Density [1] function may be used to express equal likelihood of the task completing on any of the days in the three-to-four week range. Herein, this arbitrary density function will he called the task completion density.

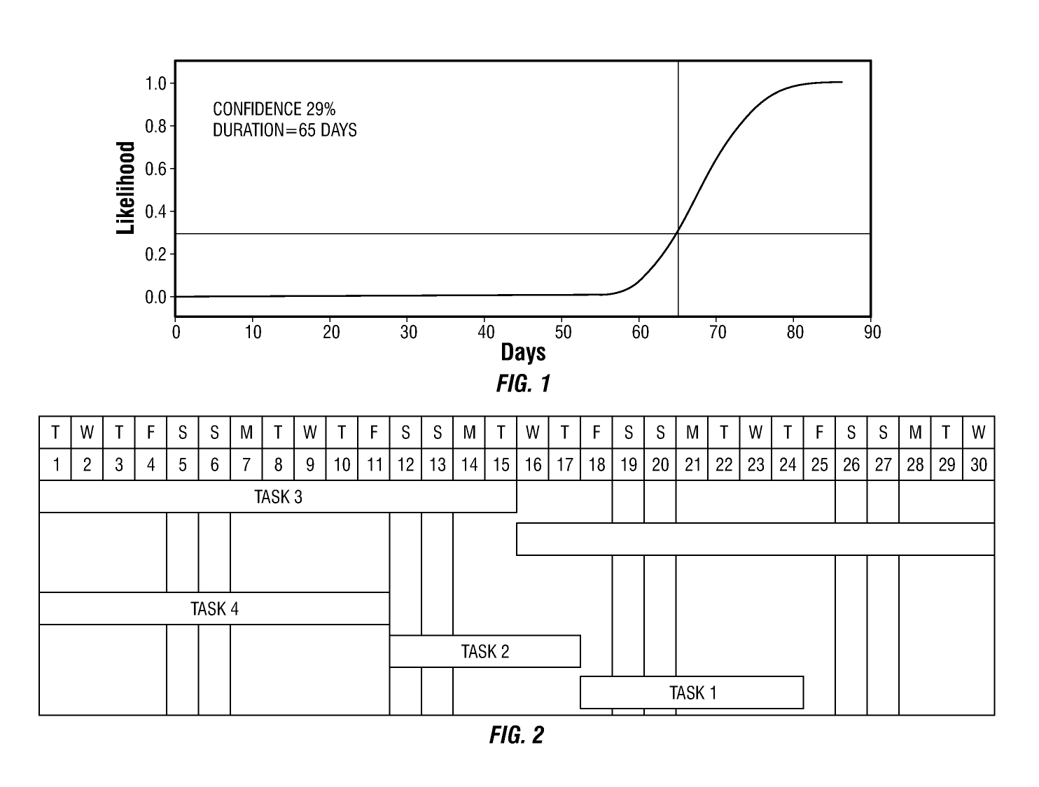

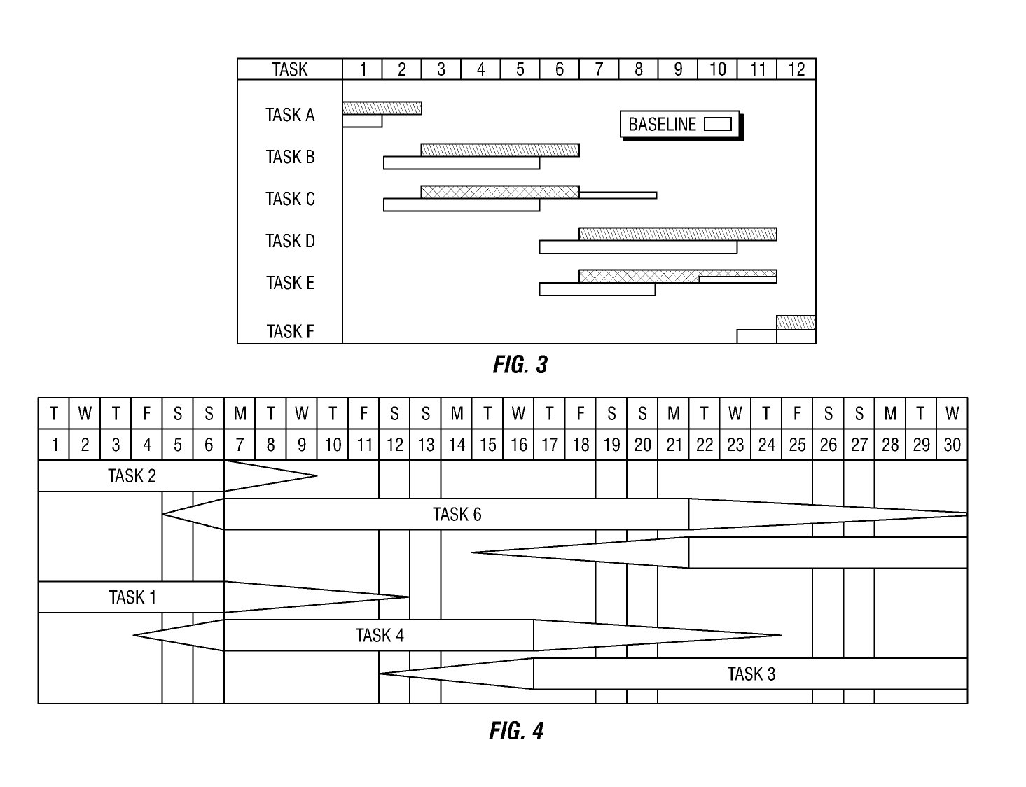

In order to plan a project, it is useful to have the date by which a certain task is expected to be complete. In order to obtain an estimate of the probability that a task will be complete by a specific date, the task completion density may be integrated to produce a probability distribution function [1] which expresses the chance of a task being complete on or before a specific point in time. Herein, this distribution function will be called the task completion distribution or completion curve (see FIG. 1).

In a project with multiple tasks, the project completion curve is derived by combining the completion curves of each task. How these curves are combined is foundational probability theory, but is summarized here as it relates to Engineering development tasks.

For Engineering development projects, this method assumes that any task that requires the output of some earlier task is said to be dependent on the earlier task, and must proceed sequentially. Otherwise, the tasks are independent, and assumed to be progressing in parallel.

Note: two otherwise independent tasks may be considered dependent if they are assigned to the same person. This model works where people tend to work on ‘one thing at a time.’ Alternatively, two such tasks can be considered truly independent, but then the expected rate of completion of any task would depend on the number of other tasks that are assigned to the same resource. Either approach can be used with the techniques described herein.

The first step is to reduce all the completion densities in a project to a single set of independent completion distributions. This is done by producing a single (combined) completion density for each set of dependent tasks.

Combining a set of dependent tasks is done by assuming that the combined density of two dependent tasks is equivalent to the probability of two sequential events. That is, the combined density is simply the convolution of the two completion density functions[2]. This process can be repeated across an arbitrary set of dependent tasks, to derive a single completion density for the set. Then the combined density is integrated to produce an independent completion distribution for each set of dependent tasks.

At this point, all the tasks in the project are represented by a set of independent completion distributions. To get the overall project completion curve, these distributions are combined by assuming the combination is equivalent to the combined probability of two independent (or parallel) events. That is, the combined completion curve is simply the product of the separate distributions [2].

Using the reductions described above, a single completion curve may be computed for any arbitrary set of tasks, or an entire project. Therefore, any point on the completion curve represents the chance of completing the selected set of tasks (or the entire project) by that point in time.

With Statistical Distributions for project tasks available, any progress point in a project (including the overall project completion) may be examined to determine the end date, given an assumed likelihood or confidence value, or alternatively, the chance of completing the tasks by a specific date can be easily obtained. This allows rapid analysis of ‘what-if’ scenarios, such as the effect of resource changes, overall impact of specific task estimates or pre-requisites, and various re-loading scenarios. As tasks are completed or estimates updated, the changes in such values may be tracked to give planners and managers an immediate evaluation of the changing risk associated with the project.

As part of the present invention, a technique to use statistical project planning to produce a traditional fixed duration project plan, according to a desired, known and specified risk is described.

The basic principle of statistical project planning is described above, but the result is a statistical completion distribution for each task (and the overall project) which gives the varying probability of completion as a function of duration. Since such distributions do not provide fixed completion durations or fixed risk factors, the information cannot be mapped directly to traditional project planning. The technique described is a map between such statistical functional attributes and the fixed durations used in traditional planning.

Given that a project has been described by one or more subtasks, and completion duration estimates are available for each subtask. It is possible to use statistical techniques to produce completion distributions for any subtask, or for the overall project. The key to this technique is that given a known risk (or confidence) factor, each distribution can be evaluated at the specified risk point to obtain a single fixed duration for any task (see FIG. 1).

By evaluating the completion duration for each task at a fixed confidence point, one can obtain the ‘end date’ for all subtasks in a project. Of course, by knowing the task interdependencies, it can also be known which task is the ‘last task’ in a project, so the overall project end date can also be known.

However, in traditional project planning the start date of a task is also of interest. Since statistical distributions do not provide a fixed start date, and each task has only a duration estimate, it takes additional analysis to derive individual task start dates with the same overall specified confidence. For any given task, this is done by identifying the tasks that must be completed before the given task can begin. These tasks may be either ‘predecessor’ tasks, whose output is used in the given task, or independent tasks assigned to the same person (assuming that multiple tasks assigned to the same person are performed in some planned order).

Once these pre-requisite tasks are identified, the statistical Completion modeling described above is used to compute the completion duration for the overall set of pre-requisites (i.e. the ‘pre-requisites end date’). Taking the specified confidence point of that function produces the start date of the given dependent task, at the specified confidence.

If this process is repeated for each task in the project, using the same fixed confidence value, the result is a set of fixed start and end dates for each task, which may be analyzed and plotted using traditional project management techniques, but with a known, fixed, project confidence level (see FIG. 2).

By using Statistical Distributions to derive fixed task boundaries, a traditional project plan may be generated, but unlike traditional techniques the project plan has a known specified risk associated with it. Using this technique, planners can even produce multiple plans at various levels of risk, and evaluate the level of acceptable risk in making project commitments.

This provides a powerful new method for an entire development organization to help manage risk in projects in a deterministic fashions, and help to reduce ‘gut feel’ risk estimation leading to low success in meeting committed project timelines.

In the present invention, each subtask is represented as a diagram comprised of a ‘ramp-up’ triangle, an optional progress rectangle, and a ‘ramp-down’ triangle. This technique visually indicates the uncertainty corresponding to the start (‘ramp-up’) and end (‘ramp-down’) dates for a task, while still placing the task in the timeline context of the project, in a Gantt-like fashion. Since the general shape of such a diagram resembles a tiger stripe, this is called a task stripe. A project chart may be made up of task stripes, composed in a manner similar to a Gantt chart, in place of the traditional Gantt rectangles (see FIG. 4). Since it is comprised of task stripes, such a chart may be called a Tiger Chart (or TChart for short).

A Task Stripe has distinct and key points that define its shape and placement along the timeline. In order to completely define the points that determine the shape of a task stripe, some definitions related to Statistical Project Management are needed. For any subtask, the following properties are defined:

TABLE 1
Key time points used to define task stripe

| Property | Definition |
|---|---|
| min | the minimum duration for the task to |
| | complete |
| max | the maximum duration for the task to |
| | complete |
| minStart | the earliest point at which a task may begin |
| maxStart | the latest point at which a task may begin |

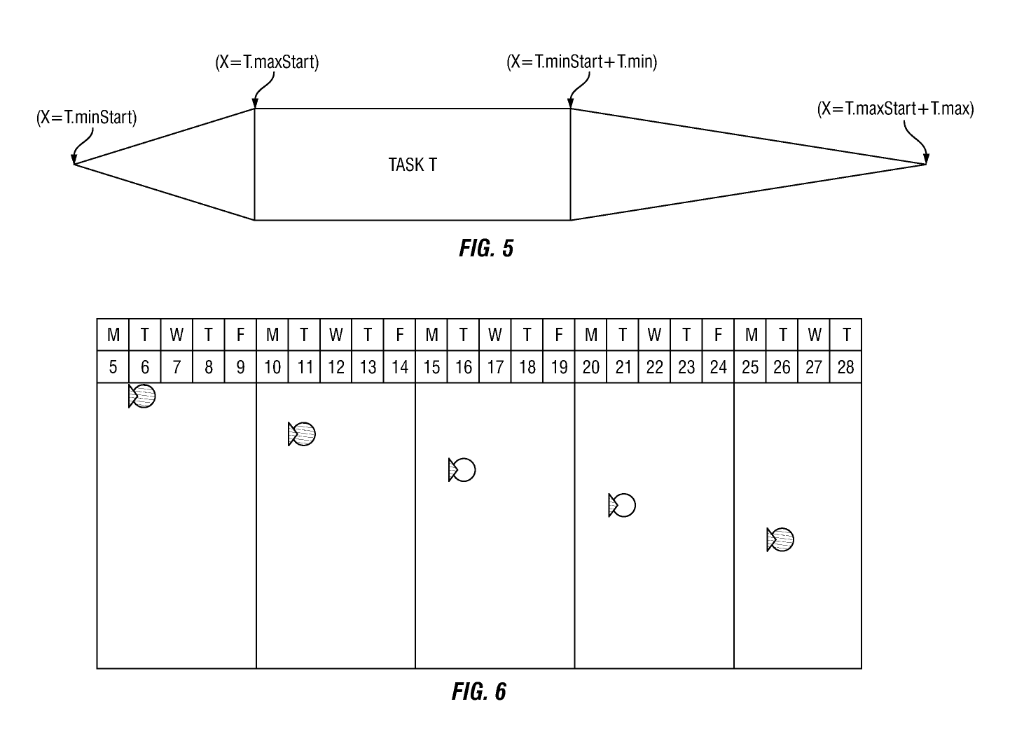

FIG. 5 shows the overall structure of a task stripe, based on the points defined in the table above.

Using the task stripe diagram for representing tasks within a timeline context allows a single chart to show both the time-order relationship between tasks, as well as the uncertainty surrounding the task's start and end dates in a single view. The visual representation of uncertainty can allow planners to quickly estimate expected completion dates and see where project dependencies have inordinately large uncertainties, all in a quick glance. The similarity between the task stripe and a traditional Gantt rectangle are intentionally designed to increase familiarity for users who have worked with Gantt charts, as well as highlight the uncertainty of task scheduling within Statistical Project Management.

Given that each subtask contributes to the project outcome function, it is possible to define a measure of that effect, called criticality, for each subtask. The criticality of a subtask is the ratio of change in the expected completion of a subtask divided by change in the expected completion of the project. This is a ratio between zero up to and including one.

As an example, assume a project is comprised of ten tasks, called T1 through T10. Each task is specified with some estimated duration range min and max; for example T0 has a range min0 to max0. Now assume the overall project duration function P(x) yields the expected project duration D at the specified confidence x:

P(x)=D

To compute the criticality for T1, a new project duration function using new values for min1 and max1 which are equal to min0 and max0 plus some small increment i is computed:

min1′=min1+i

min2′=min2+i

P′(x)=D′

The criticality for T1 at confidence x is C1 and therefore defined as:

C1=i/(D′−D)

In like fashion, the criticality measure of all subtasks in a project may he computed, and the list of tasks ranked according to decreasing criticality. It is worth noting that if any task estimates change as a project progresses, the project duration function will also change, and the criticalities must be recomputed.

Criticality as a measure of interest has many advantages over the critical path identification method. The most significant of these is the ability to simultaneously identify multiple unrelated tasks that can have a significant effect on the project completion. By its nature critical path identifies a single task or set of dependent tasks only.

Also, since criticality takes into account the contributions from all tasks and rates them accordingly, project managers can more easily and accurately prioritize time spent managing subtasks. Noting significant changes in the criticality values or rankings of certain tasks also provides a key indicator of potential problem areas before they actually become the ‘critical path.’

In statistical Project Management, the project completion estimation is a function of contributions from all subtasks. Although the actual completion probability for the project can be a complicated transfer function involving the completion probabilities of many tasks, the actual targeted completion date is generally driven by a traditional critical path effect. However, since Statistical Project Management allows tasks to have a probabilistic completion function, there can be many tasks which, if their completion slips past the target date, would end up becoming critical and affecting the project end date.

Therefore, the potential for a task to become critical must be assessed, requiring that the probability of each task completing at a time that is likely to impact the project completion is accounted for. A metric directly related to this probability, which accounts for the lag of a task, can be called a task's Risk Assessment, or R-value; tasks can be ranked in order from most significant (i.e. highest R-value) to least as a way of highlighting the tasks most likely to affect the project end date.

Unlike a simple critical path method, R-value ranking can simultaneously identify even otherwise unrelated tasks that have high probability of impacting the overall project completion. Since the list is a function of all subtasks, Project managers can focus attention on the tasks most likely to affect the project outcome, without worrying about “hidden’ critical tasks.

In non-statistical project planning, the critical path is the set of sequential tasks with zero lag, where lag is defined as the amount of time between the completion of the last task in a sequence, and the completion of the entire project. Define:

L−Lag (from zero to some N number of units)

Tasks in the critical path (or simply critical tasks) are therefore considered to be the gating factor in reducing the overall duration of the project, and the highest risk to the project schedule.

In Statistical Project Management (SPM), there is no critical path since the project completion is a probability function rather than a fixed date. However, the target completion date of a task (or of a project) is the nominal completion date. It is expected that the completion of a task (or project) will occur sometime between a minimum and maximum duration, with a nominal target date somewhere in-between.

T=task's target duration

Using this notion, it is possible to determine a Lag value, even in SPM, based on the difference between the target completion dates for each sequence of tasks, compared to the target completion date for the entire project.

In SPM, a probability distribution is computed for each task using a suitable model, which is then combined with other tasks to derive the overall completion probabilities for the project. The completion probability function ranges from zero to one across the range from the task minimum to the task maximum duration. This is called completion probability function C(x):

C(x)=completion distribution for a single task

For any task, the risk to the end-date of the project is proportional to the probability that the task will complete after a date which uses up the smallest lag for any path that the task is on. Since C(x) represents the probability that task is complete on or before a given date, it is easily defined as an inverse function called IC(x) which represents the probability of a task completing after a given date:

IC(x)=1−C(x)

If it is defined the Risk Assessment metric as R, R might be defined simply as IC(x) at the point in the curve is where x is equal to the target date plus the lag:

Proposed R=IC(x) where x=T+L

However, it is also noted that as x varies from minimum to maximum, IC(x) ranges from 1 down to zero, but it is preferred that R=1 if the task completes exactly on the target date plus the lag. This would make it such that R=1 is analogous to the traditional critical task. For a single task, the chance of completion on the target date is typically 50% (0.5), therefore, if x=target and lag=zero, IC(x) is approximately 0.5; therefore, using two as a scaling factor, R is finally defined:

R=2*IC(x) where x=T+L

Risk Assessment as a measure of interest has many advantages over the traditional critical path method. The most significant of these is the ability to simultaneously identify multiple unrelated tasks that have the most likelihood of impacting the project completion. By its nature critical path identifies a single sequence of tasks only.

Also, since Risk Assessment ranking takes into account all tasks and rates them accordingly, project managers can more easily and accurately prioritize time spent managing subtasks. As a project progresses, a manager might take note of significant changes in the R values or rankings of certain tasks also provides a key indicator of potential problem areas before they actually become critical.

The present invention involves a modified technique of statistical project planning which can be used to model the generally decreasing amount of uncertainty as a project progresses, and therefore quantify the uncertainty as a dynamic project parameter. Analysis of this uncertainty can give project planners earlier indication of potential project issues, and help to identify specific tasks or resources where problems may need to be addressed.

The basic principle of statistical project planning is described above, but the result is a statistical completion distribution for each task (and the overall project) which gives the varying probability of completion as a function of duration. Since the task duration estimates are taken at planning time, they represent a certain amount of uncertainty in the project. As a project progresses, tasks are updated with new estimates of the remaining work, but if the initial uncertainty range is not reduced, the statistical estimates will reflect a much greater amount of uncertainty than actually exists in the project, especially for tasks that are nearing completion. Put another way, if a task is half complete, it should be assumed that there is less uncertainty than before the task was started, and therefore the estimated completion range should be smaller.

The simplest method of doing this is to scale the original estimated duration range by the task's current percent completion. Using these revised estimates, statistical computations can account for varying uncertainty as a task progresses.

Given that a project has been described by one or more subtasks, and completion duration estimates are available for each subtask. It is possible to use statistical techniques to produce completion distributions for any subtask, or for the overall project [2]. The statistical method uses the estimated completion range for a subtask, given before the project begins, to compute the completion probabilities. At that point, all tasks are zero percent complete, and the difference between the maximum duration of a subtask, and the minimum duration may be called the uncertainly spread.

As a project progresses, each subtask's uncertainty is scaled by current percent completion estimate. That is, an effective uncertainty spread Ux( ), can be computed by linear scale against the remaining work, and expressed as follows:

U(x)=x*(max−min)

Where x is the ratio of estimated remaining work on a subtask divided by the estimated total amount of work. This number ranges from 1 (initially) down to zero as the task is complete.

Adding back this uncertainty spread to the current remaining work estimate gives new estimates for minimum and maximum durations.

For example, if a task was given an original duration estimate of four to six weeks, the original uncertainty spread would be two weeks (six weeks minus four weeks). At some later point, after the task has been worked on for three weeks, the engineer estimates that there are two weeks remaining on the task. At this point, the task is estimated to be 60% complete, since three weeks of work are done, and three weeks plus the estimated two weeks remaining puts the current total work estimate at five weeks. That yields an uncertainty scaling factor of 0.4 (40% remaining work), and using that against the original uncertainty spread of two weeks gives a new uncertainty spread of 0.4×2=0.8 weeks or about 4 working days, or +/−2 days.

Thus, the new effective estimate for the completion of the task is two weeks (10 days) plus or minus 2 days. In other words, the new minimum is 8 more days, and the new maximum is 12 more days.

By using a linear decreasing uncertainty spread, Statistical Distributions for task completions can take into account the decreasing uncertainty of a task duration as the task nears completion, without requiring engineers to constantly re-evaluate the uncertainty. In this way, status updates to report task progress are simplified to a single “work remaining” estimate, and statistics will automatically adjust to fit a simple uncertainty progression model. This makes the resulting project-wide statistics more indicative of the actual uncertainty as a project progresses, providing more valuable information for ongoing uncertainty tracking throughout the duration of the project.

In the present invention, a new software entity called a ‘tracepoint’ is invented, in order to represent a collection of tasks to be monitored. A tracepoint is rendered as a simple graphical entity, such as a circle, whose fill color represents the probability of meeting a desired completion date. Multiple tracepoints can be displayed together, to give an ‘at-a-glance’ status of the completion probabilities of various tasks of interest across the project.

A tracepoint is a project object which can represent the completion probability of a task or set of tasks, against some targeted completion date. Each tracepoint defined in a project is associated with one or more tasks, a set of probability thresholds, and a target completion date. A tracepoint is rendered as a simple graphical entity, for example a small circle, for visual display.

The tracepoint display algorithm will obtain the combined CC curve for the associated tasks, and evaluate it at its completion target date. This value can be called the Target Probability (TP). Next, it applies specified thresholds to determine what state the tracepoint is in. For example, a tracepoint could be given upper and lower probability thresholds of 75% and 50%, to determine the result.

If TP is below the lower threshold, the tracepoint might show RED; if the TP is between the two thresholds, the tracepoint might show YELLOW, and if the TP is above the upper threshold, the tracepoint might show GREEN. Note that the choice of visual indication is arbitrary; various fill patterns could be used instead for monochromatic displays or print output.

With a collection of such tracepoints defined for a project, one can create an ‘at-a-glance’ project summary, simply by visually examining all tracepoints. Any tracepoints which indicates an unacceptable completion probability automatically leads the observer to the task(s) which are unlikely to meet the desired completion date according to the threshold criteria (see FIG. 6).

Using tracepoints for evaluating completion probabilities makes it possible to quickly get an overall status of the project without resorting to ‘manual’ CC analysis. A collection of tracepoints provides a consolidated, concise, graphic representation of project status, suitable for high-level reporting. In addition, tracepoint status changes could be used to trigger events; for example, if a tracepoint goes YELLOW, an email is sent to a Project Manager with details.

What is described herein is a technique of deriving a quantitative measure of the suitability of resource assignments. Once the suitability measurement is obtained, it can be used as a per-task cost factor, in effect adjusting the task cost according to the ‘goodness’ of the resource fit.

This method uses a common set of descriptive labels, called Attribute Tags; each tag is unique in the set, and describes a particular attribute of a task or resource that is considered potentially important to execution of a task. For example, “fire retardant” or “CPA” are examples of attribute tags.

Each resource available for use in a project, and each task to be performed are associated with one or more tags from the project tag set. The suitability of an assignment is based on the number of matches between the tags associated with the task and the tags associated with the resource.

Using domain knowledge, weights assigned to task attribute tags may be chosen to reflect this cost in heuristically known ways. In other words, and for example, if it is known by those experienced in the domain that using poured concrete for construction costs twice as much as using pre-cast, then for a given task, the ‘pre-cast concrete’ attribute should have a weight which is twice that of the ‘poured concrete’ tag. In this way (for this example), both options are represented by attribute tags for a given task, but the resource selection will yield different suitability. Also, the suitability value will be proportional to the cost on the project.

All that remains is to use the suitability value as a scaling factor against the total project cost. In this way, any number of possible uses of a fixed set of resources may be tried, and the resulting project cost impact can be immediately computed or observed. This creates the potential for a feedback-loop system for optimizing the project cost as a function of resource assignment.

The set of tags actually represents a great deal of domain-specific knowledge, and would be developed carefully for an organization, perhaps using historical data and legacy knowledge of the processes and resources traditionally used in typical projects.

However, once a set of tags is defined, resources and tasks are associated with one or more tags. Each tag associated with a task also carries a measure of importance to that task. This tag weighting, allows a more precise specification of the relative cost effect of matching various tags. For example, the skill set needed by a person who would be assigned to a task may be expressed as a list of weighted tags, with some skills more important than others.

Once the appropriate domain-specific tags and weights are chosen, the suitability value is computed by simply adding the weights of the tags which match between task and resource. Once the suitability value is computed, the projected cost is adjusted by simply dividing it by the suitability. The resulting estimate can be called the Suitability Cost (SC) which represents the task cost, adjusted for the suitability of the current resource assignment. The SC is computed as:

SC=Task Cost/Suitability

Therefore, the SC can be computed as the sum of all costs for each resource, and result in the overall project cost, adjusted for resource assignment suitability.

Using the described suitability measure and cost factoring provides a quantitative method for measuring the ‘goodness’ of resource assignments on project tasks. The attribute tags and weights capture domain-specific knowledge relating the importance of such matches to actual project cost.

Once these weights are developed and proven, project estimates can be adjusted by suitability factors to achieve a higher level of accuracy. Also, project cost may be optimized along resource utilization in a quantifiable way, insuring the most appropriate use of limited resources.

In addition, since the results of this method are quantitative, this approach can be used within a feedback-loop system which can fly and evaluate various resource assignment combinations. Such a system could then be used to arrive at an optimum solution to minimize project cost, even in an automated way.

Abbreviations

TP—Targeted Probability

SPM—Statistical Project Management

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

### REFERENCES

[1] Stat Trek (2007). Statistics Tutorial: Probability Distributions, URL: http://stattrek.com/Lesson2/ProbabilityDistribution.aspx?Tutorial=Stat.
[2] Patrick Billingsley (1979). Probability and Measure. New York, Toronto, London: John Wiley and Sons.
[3] Wysocki, R. K. and Beck, R. and Crane, D. B. (2000). Effective project management, John Wiley & Sons New York.
[4] Phillip G. Armour (2007), Twenty Percent. (Commun. ACM), ACM, New York, N.Y.
[5] Robert Wysocki (2006), Effective Software Project Management. John Wiley & Sons, Inc., New York, N.Y.
[6] Wikipedia (2008), Critical path method, Wikipedia, The Free Encyclopedia, http://en.wikipedia.org/w/index.php?title=Critical_path_method&oldid=228527258.
[7] Phillip G. Armour (2007), Cone of Uncertainly. (Commun. ACM), ACM, New York, N.Y.

1. A method for a Gantt chart comprising the steps of:
determining a range of dates for an end date for completing a task with a processing unit, the range comprising a first date and a final date; and
showing on a display the range of dates for the task completion.

2. The method of claim 1 including the step of determining a range of a project end date from a range of end dates for all tasks of the project.

3. The method of claim 2 including the step of establishing with the processing unit dates for each task and date based on a completion date for the project.

4. The method of claim 1 including the step of producing with the processing unit a strip for the display that shows the range in which the task can occur, the strip having a head and a tail associated with each task end date range, where the length of the head and tail corresponds to a ramp-up and a ramp down period of the associated task.

5. The method of claim 3 including the step of determining with the processing unit each task's criticality in affecting the project's completion date being met.

6. The method of claim 5 including the step of the processing unit assessing each task's risk as a function of the task's criticality, maximum duration and lag, where lag is defined as an amount of time between completion of a last task in a sequence of tasks, and the completion date of the project.

7. The method of claim 2 including the step of the processing unit resetting the range of the end date for the task when at least a portion of the task is completed.

8. The method of claim 7 including the step of the processing unit resetting the range of the project end date after resetting the range of the end date for the task.

9. The method of claim 1 including the step of the processing unit reporting a likelihood of achieving a completion date in the range of the end date.

10. An apparatus for a Gantt chart comprising:
a processing unit which determines a range of dates for an end date for completing a task, the range comprising a first date and a final date; and
a display which shows the range of dates for the task completion

11. The apparatus of claim 10 wherein the processing unit determines a range of a project end date from a range of end dates for all tasks of the project.

12. The apparatus of claim 11 wherein the processing unit establishes dates for each task end date based on a completion date for the project.

13. The apparatus of claim 10 wherein the processing unit produces a strip for the display that shows the range in which the task can occur, the strip having a head and a tail associated with each task end date range, where the length of the head and tail corresponds to a ramp-up and a ramp down period of the associated task.

14. The apparatus of claim 11 wherein the processing unit determines each task's criticality in affecting the project's completion date being met.

15. The apparatus of claim 14 wherein the processing unit assesses each task's risk as a function of the task's criticality, maximum duration and lag, where lag is defined as an amount of time between completion of a last task in a sequence of tasks, and the completion date of the project.

16. The apparatus of claim 11 wherein the processing unit resets the range of the end date for the task when at least a portion of the task is completed.

17. The apparatus of claim 16 wherein the processing unit resets the range of the project-end date after resetting the range of the end date for the task.

18. The apparatus of claim 10 wherein the processing unit reports a likelihood of achieving a completion date in the range of the end date.

19. An apparatus for establishing a project's performance comprising:
a database having data about each task of the project, resources available to perform each task, tags which have at least one attribute about task or resource, and having a suitability module; and
a processing unit which executes the suitability module that compares tags of the resources and the tasks and determines which tasks are to be performed by which resources to optimize the project's performance.

20. The apparatus of claim 19 wherein the data in the database about the tags includes a weighting associated with each tag and the suitability module, when executed by the processing unit, selects resources to perform tasks based on a highest number of tags which match between the resources and the tasks and also in order of the task's weighting.

21. A method for establishing a project's performance comprising:
obtaining from a database data about each task of the project, resources available to perform each task, and tags which have at least one attribute about task or resource; and
executing a suitability module with a processing unit that compares tags of the resources and the tasks and determines which tasks are to be performed by which resources to optimize the project's performance.

22. The method of claim 21 wherein the data, in the database about the tags includes a weighting associated with each tag and the executing step includes the step of executing the suitability module by the processing unit to select resources to perform tasks based on a highest number of tags which match between the resources and the tasks and also in order of the task's weighting.
